(19) United States
(12) Patent Application Publication
(10) Pub. No.: US 2012/0019636 A1
(43) Pub. Date: Jan. 26, 2012

(54) Stereoscopic 3D Images and Video on a Non-Stereoscopic 3D Capable Screen

(75) Inventors: Hagai Gefen, Chatsworth, CA (US); Teemu Nivala, Leicester (GB); Joseph Cruz, Chatsworth, CA (US)

(73) Assignee: GEFEN, LLC., Chatsworth, CA (US)

(21) Appl. No.: 12/842,849

(22) Filed: Jul. 23, 2010

(51) Int. Cl. H04N 13/04

(52) U.S. Cl. 348/55; 348/E13.075

(57) ABSTRACT

A method of providing a stereoscopic 3D image or video on a non-stereoscopic 3D screen. This includes receiving an alternating frame sequence of left and right images where a marker is embedded into the left or the right image. The alternating sequential frame with the embedded marker is output to the non-stereoscopic 3D screen. The markers outputted from the non-stereoscopic 3D screen are detected by an optical sensor. A synchronization signal is sent via a communication channel to an eye control device to synchronize the eye control device with the non-stereoscopic 3D screen, based on the detected markers displayed on the screen.

### BACKGROUND OF THE INVENTION

1. Field of the Invention

This invention relates to viewing stereoscopic 3D images and video on non-stereoscopic 3D capable screens.

2. Description of Related Art

Stereoscopic 3D screen technology has recently increased in popularity with consumers and allows a viewer to perceive images in stereoscopic 3D. A plethora of methodologies and standards exist for displaying stereoscopic 3D images and video. Many of these techniques are proprietary and all require specialized equipment and screens. In particular, a stereoscopic 3D capable screen is necessary to properly display a stereoscopic 3D video source because a stereoscopic 3D video source outputted form a non-stereoscopic 3D capable screen is unwatchable. However, the vast majority of screens in use today, are not compatible with stereoscopic 3D image and video input sources.

Although consumers and businesses may desire to adopt stereoscopic 3D technology, purchasing and replacing a non-stereoscopic 3D screen with a stereoscopic 3D capable screen may be cost prohibitive. For some consumers, the merits of stereoscopic 3D simply may not outweigh the cost savings of maintaining a conventional non-stereoscopic 3D capable screen.

### SUMMARY OF THE INVENTION

The present invention overcomes these drawbacks of the prior art and provides a device, system and method of outputting and synchronizing stereoscopic 3D images and videos onto a screen for accurate, stereoscopic 3D viewing by a user. The present invention may function as a stand-alone device or be incorporated into other devices. Therefore, older or less technologically advanced screens may be adapted to properly display stereoscopic 3D images without having native stereoscopic 3D screen support, thereby increasing the lifecycle of a screen and saving consumers from the cost of a full upgrade. The present invention is not limited to non-stereoscopic 3D capable screens and may be applied to any screen.

One embodiment of the invention is a method of providing a stereoscopic 3D image on a screen. An alternating frame sequence of left and right images is received with a marker embedded into the left or the right image. The alternating sequential frame is output to the screen. The markers outputted from the screen are detected. A synchronization signal is outputted to synchronize an eye control device with the screen based on the detected markers.

The left and right images displayed are determined based on the marker detected. The stereoscopic 3D image is separated into the alternating frame sequence where the stereoscopic 3D image includes the left and right images in a single frame. The eye control device actively controls viewing for left and right eyes based on the synchronization signal. Display of the left image is synchronized with the left eye and display of the right image is synchronized with the right eye. The marker for the left image is different from the marker for the right image should the signal processor embed markers to both left and right images.

In another embodiment of the invention, a converter device provides a stereoscopic 3D image on a screen. The converter includes a signal processor that receives an alternating frame sequence of left and right images, embeds a marker into the left or right image, and outputs the alternating frame sequence to the screen. An optical sensor detects the markers displayed from the screen. A synchronizer connected to the optical sensor generates a synchronization signal that synchronizes the screen with an eye control device based on the optical sensor detection.

A transmitter connected to the synchronizer transmits the synchronization signal to the eye control device. The synchronizer determines which of the left and right images is displayed based on the optical sensor detection. The signal processor separates the stereoscopic 3D image into the alternating frame sequence where the stereoscopic 3D image from the stereoscopic 3D source includes the left and right images in a single frame.

In another embodiment of the present invention, a system for viewing a stereoscopic 3D image on a screen includes an eye control device having left and right eye filters, and a converter having a signal processor, an optical sensor and a synchronizer. The signal processor receives an alternating frame sequence of left and right images, embeds a marker into the left or the right image, and outputs the alternating frame sequence to a screen. The optical sensor detects the markers displayed on the screen. A synchronizer connected to the optical sensor generates a synchronization signal that synchronizes the screen with the eye control device based on the optical sensor detection.

A transmitter connected to the synchronizer transmits the synchronization signal to the eye control device. The signal processor separates the stereoscopic 3D image received from the stereoscopic 3D source in which the left and right images are contained within a single frame into an alternating left and right image frame sequence. The eye control device actively controls viewing for left and right eyes. The display of the left image is synchronized with the left eye and the display of the right image is synchronized with the right eye. The optical sensor is placed accordingly for detection of the marker. A stereoscopic 3D image source generates the stereoscopic 3D image.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a block diagram according one embodiment of the present invention.

FIG. 2 is a flowchart according to another embodiment of the present invention.

### DETAILED DESCRIPTION OF THE INVENTION

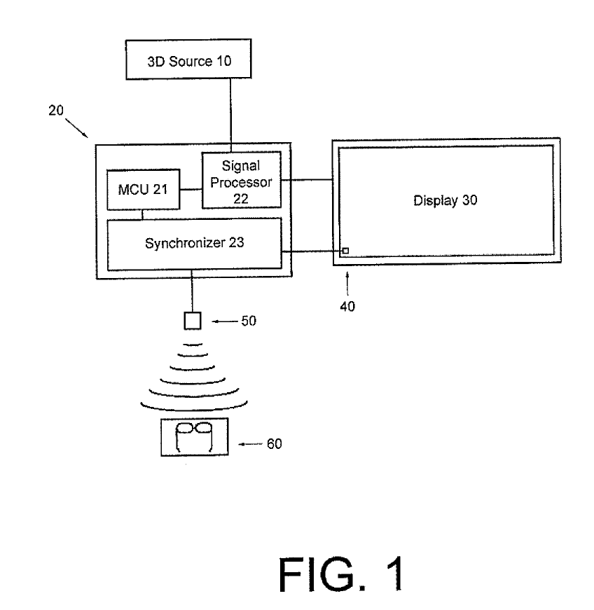

One embodiment of the present invention is illustrated in the block diagram of FIG. 1. Converter 20 is connected to screen 30 and receives a stereoscopic 3D image outputted from stereoscopic 3D image source 10. stereoscopic 3D image source 10 may be any source capable of providing stereoscopic 3D images, such as for example, a recordable media player, a set top box, a LAN, video game console or the like. Converter 20 includes an input port for receiving a stereoscopic 3D image signal and an output port for transmitting the modified stereoscopic 3D signal to screen 30. In an alternative embodiment, stereoscopic 3D image source 10 is incorporated into converter 20. The operation of converter 20 is discussed in greater detail below. Screen 30 may be of any size and can be a Projector, CRT, LCD, OLED, PDP or any other type of screen. While the present invention is most useful for a screen incapable of correctly displaying a stereoscopic 3D image, the invention may be applied to stereoscopic 3D capable screens as well.

Converter 20 includes micro-controller unit (MCU) 21, signal processor 22 and synchronizer 23. MCU 21 controls and provides user configuration of converter 20. Signal processor 22 receives input stereoscopic 3D images from stereoscopic 3D image source 10. The stereoscopic 3D images may be a stereoscopic video stream where a single image frame includes both left and right images. In this case, signal processor 22 separates the single frame into an alternating frame sequence of individual left image and right image frames. Alternatively, the stereoscopic 3D images may be input to signal processor 22 as an alternating frame sequence of left and right images. In either case, once the alternating frame sequence is provided, signal processor 22 embeds markers into left or right or both frames.

Signal processor 22 embeds a marker into left or right or both image frames. In the case for both, the left image marker is different from the right image marker so that the left and right images are differentiated from each other. The visual markers can vary at any time and are not limited in size, shape, placement or color so long as they are detectable by optical sensor 40. For example, the markers may be rectangular boxes provided in a bottom corner of the images in different colors.

Once the embedded markers are added to the alternating frame sequence, signal processor 22 outputs the alternating frame sequence to screen 30. The alternating frame sequences are displayed by screen 30 with the embedded markers visible to optical sensor 40 on screen 30. Next, optical sensor 40 is provided to detect the displayed markers and outputs the optical sensor detection to synchronizer 23 of converter 20. Optical sensor 40 is placed accordingly so as to be able to detect the markers and is preferably as small as possible. Optical sensor 40 is preferably placed over the embedded marker on the screen so as to overlap the portion of the screen where the markers are embedded. However, optical sensor 40 may also be placed at a distance from the screen that allows optical sensor 40 to detect the marker displayed on the screen. Optical sensor 40 may be connected by wires or wirelessly to converter 20 and transmit the required information (i.e. embedded marker data) to synchronizer 23.

Since different screens have different performance characteristics, the display of stereoscopic 3D images on different screens will vary such that synchronization of the screen with the eye control device must be performed. The embedded markers and optical sensor detection allow synchronizer 23 to analyze the timing of the left and right images. Synchronizer 23 then determines which of the left and right images is displayed based on the marker detected by optical sensor 40. Next, synchronizer 23 calculates the video signal delay and compensation necessary, if any, to provide proper synchronization with eye control device 60. A synchronization signal is then generated to synchronize the display of the left and right images with eye control device 60. The synchronization signal compensates for the stereoscopic 3D signal delay, if any, between the displayed image and eye control device 60.

Transmitter 50 is connected to synchronizer 23 and outputs the synchronization signal to eye control device 60 through a wired or wireless connection through any known protocol. Eye control device 60 actively controls the viewing of a left eye and a right eye in sync with screen 30 such that screen of a left image is synchronized with the left eye and screen of the right image is synchronized with the right eye. Eye control device 60 includes left and right eye filters to actively control eye viewing. For example, when the left image is displayed, the left eye is able to view the left image while viewing of the left image by the right eye is prevented. Likewise, when the right image is displayed, the right eye is able to view the right image while viewing of the right image by the left eye is prevented. Eye control device 60 may be, for example, a pair of active shutter glasses, active polarizing filters, or any other device that separates left and right stereoscopic 3D images for viewing by left and right eyes. Eye control device 60 is not limited by a specific implementation of how left and right eye control is provided and need not embody wearable glasses.

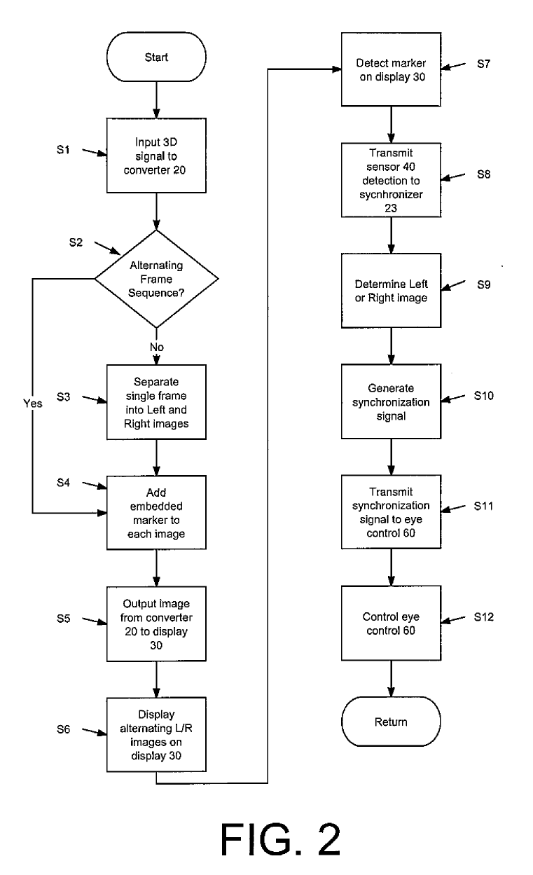

FIG. 2 describes in detail the steps performed to carry out the stereoscopic 3D display and synchronization process of the invention. The process begins in step S1 with a stereoscopic 3D image signal input to signal processor 22 of converter 20. As discussed previously, the stereoscopic 3D image may be generated from an external stereoscopic 3D image source 10 or within converter 20. Signal processor 22 analyzes the stereoscopic 3D image and determines if it is in an alternating frame sequence format in step S2. If the stereoscopic 3D image is not in the alternating frame sequence, it is separated into individual and sequential left and right images in step S3. Next, markers are embedded into left or right or both images (S4). Signal processor 22 then outputs all the images, embedded or not, to screen 30 (S5). While the alternating frame sequence is displayed on screen 30 in step S6, optical sensor 40 detects the presence of markers seen on screen 30 in step S7. In step SB, the sensor 40 detection is transmitted to synchronizer 23. Synchronizer 23 determines which image (left or right) is shown based on the detected markers (S9). If the left image is displayed, then eye control device 60 is instructed to turn off right eye viewing and allow left eye viewing. Synchronizer 23 calculates the video signal delay, if any, between the on-screen image and eye control device 60 and then generates a synchronization signal for output to eye control device 60 (S10). In step S11, transmitter 50 transmits the synchronization signal to eye control device 60. Eye control device 60 receives the synchronization signal in step S12 and operates device 60 accordingly to control the viewing of each of the left and right eyes. In this manner, the present invention allows a viewer to enjoy stereoscopic 3D content from a non-stereoscopic 3D capable screen.

The particular embodiments of the invention described in this document are illustrative and not restrictive. Modification may be made without departing from the spirit and scope of the invention as defined by the following claims.

I claim:

1. A method of providing a stereoscopic 3D image on a screen, comprising:
receiving an alternating frame sequence of a left image and a right image;
embedding a marker into the left or the right image;
outputting the alternating sequential frame to the screen;
detecting the marker outputted from the screen; and
outputting a synchronization signal to synchronize an eye control device with the screen based on the detected marker.

2. The method according to claim 1, further comprising:
determining which of the left or the right image is displayed based on the marker detected.

3. The method according to claim 1, further comprising:
separating the stereoscopic 3D image into the alternating frame sequence.

4. The method according to claim 3, wherein the stereoscopic 3D image includes the left and right images in a single frame.

5. The method according to claim 1, wherein the eye control device actively controls viewing for left and right eyes based on the synchronization signal.

6. The method according to claim 5, wherein the screen of the left image is synchronized with the left eye and the screen of the right image is synchronized with the right eye.

7. The method according to claim 1, wherein when the markers are embedded to both left and right sequential images, the left image marker is different from the right image marker.

8. A converter device for providing a stereoscopic 3D image on a screen, comprising:
a signal processor that receives an alternating frame sequence of left and right images, embeds a marker into the left or the right image, and outputs the alternating frame sequence to the screen;
an optical sensor that detects the marker outputted from the screen; and
a synchronizer connected to the optical sensor that generates a synchronization signal that synchronizes the screen with an eye control device based on the optical sensor detection.

9. The converter device according to claim 8, further comprising:
a transmitter connected to the synchronizer that transmits the synchronization signal to the eye control device.

10. The converter device according to claim 8, wherein the synchronizer determines which of the left image or the right image is displayed based on the optical sensor detection.

11. The converter device according to claim 8, wherein the signal processor separates the stereoscopic 3D image into the alternating frame sequence.

12. The converter device according to claim 11, wherein the stereoscopic 3D image includes the left and right images in a single frame.

13. A system for viewing a stereoscopic 3D image on a screen, comprising:
an eye control device comprising left and right eye filters; and
a converter comprising a signal processor, an optical sensor and a synchronizer, wherein
the signal processor receives an alternating frame sequence of left and right images, embeds a marker into the left or the right image, and outputs the alternating frame sequence to the screen,
the optical sensor detects the marker displayed on the screen, and
a synchronizer connected to the optical sensor that generates a synchronization signal that synchronizes the screen with the eye control device based on the optical sensor detection.

14. The system according to claim 13, further comprising:
a transmitter connected to the synchronizer that transmits the synchronization signal to the eye control device.

15. The system according to claim 13, wherein the signal processor separates the stereoscopic 3D image into the alternate frame sequence.

16. The system according to claim 13, wherein the eye control device actively controls viewing for left and right eyes.

17. The system according to claim 16, wherein the screen of the left image is synchronized with the left eye and the screen of the right image is synchronized with the right eye.

19. The system according to claim 13, wherein the optical sensor is placed accordingly for detection of the embedded marker displayed on the screen.

20. The system according to claim 13, further comprising:
a stereoscopic 3D image source generating the stereoscopic 3D image.
